(19) United States
(12) Patent Application Publication
(10) Pub. No.: US 2026/0369882 A1
(43) Pub. Date: Nov. 19, 2026

(54) ANTENNA DEVICE AND VEHICLE ANTENNA DEVICE

(71) Applicant: AUO Corporation, Hsinchu City (TW)

(72) Inventors: Yi-Cheng Lai, Hsinchu City (TW); Chung-Hung Chen, Hsinchu City (TW); Shih-Hsien Yang, Hsinchu City (TW); Yu-Chih Wang, Hsinchu City (TW)

(73) Assignee: AUO Corporation, Hsinchu City (TW)

(21) Appl. No.: 19/307,001

(22) Filed: Aug. 21, 2025

(30) Foreign Application Priority Data
May 16, 2025 (TW) 114118514

(51) Int. Cl. H01Q 3/36; H01Q 1/12; H01Q 1/32; H01Q 3/28

(52) U.S. Cl. CPC H01Q 3/36; H01Q 1/1271; H01Q 1/3233; H01Q 1/3275; H01Q 3/28

(57) ABSTRACT

Provided is an antenna device, which includes a circuit substrate, multiple beamforming chips, and multiple radio frequency front-end chips. The circuit substrate includes a substrate, multiple antenna electrodes, a thin film circuit structure, and a redistribution structure. The antenna electrodes are arrayed in an antenna array region over the substrate. The thin film circuit structure is located over the substrate. The redistribution structure is located over the thin film circuit structure. The beamforming chips are arrayed in the antenna array region over the substrate, and bonded to the redistribution structure. The radio frequency front-end chips are arrayed in the antenna array region over the substrate, and bonded to the redistribution structure. The radio frequency front-end chips are respectively signal connected to the antenna electrodes. The radio frequency front-end chips are electrically connected to the beamforming chips.

### CROSS-REFERENCE TO RELATED APPLICATION

This application claims the priority benefit of Taiwan application serial no. 114118514, filed on May 16, 2025. The entirety of the above-mentioned patent application is hereby incorporated by reference herein and made a part of this specification.

### BACKGROUND

### Technical Field

The disclosure relates to an antenna device, and particularly relates to a vehicle antenna device.

### Related Art

In modern life, the application of wireless communication technology has become extremely widespread. In major cities and public spaces, the configuration of wireless local area networks (WLAN) has become basic infrastructure. Many households have also established dedicated wireless networks. With the continuous development of wireless communication technology, numerous manufacturers are committed to developing antenna devices with superior performance. Generally, high-frequency signals (such as radio frequency signals) are prone to generate loss during transmission. Therefore, how to effectively reduce signal loss during transmission has become an important topic in antenna device development.

### SUMMARY

The disclosure provides an antenna device and a vehicle antenna device, which can decrease signal loss during transmission and reduce manufacturing costs.

At least one embodiment of the disclosure provides an antenna device, which includes a circuit substrate, multiple beamforming chips, and multiple radio frequency front-end chips. The circuit substrate includes a substrate, multiple antenna electrodes, a thin film circuit structure, and a redistribution structure. The antenna electrodes are arrayed in an antenna array region over the substrate. The thin film circuit structure is located over the substrate. The redistribution structure is located over the thin film circuit structure. The beamforming chips are arrayed in the antenna array region over the substrate, and bonded to the redistribution structure. The radio frequency front-end chips are arrayed in the antenna array region over the substrate, and bonded to the redistribution structure. The radio frequency front-end chips are respectively signal connected to the antenna electrodes. The radio frequency front-end chips are electrically connected to the beamforming chips.

At least one embodiment of the disclosure provides a vehicle antenna device, which includes a circuit substrate, multiple beamforming chips, and multiple radio frequency front-end chips. The circuit substrate includes a substrate, multiple antenna electrodes, a thin film circuit structure, and a redistribution structure. The antenna electrodes are arrayed in an antenna array region over the substrate. The thin film circuit structure is located over the substrate. The redistribution structure is located over the thin film circuit structure. The beamforming chips are arrayed in the antenna array region over the substrate, and bonded to the redistribution structure. The radio frequency front-end chips are arrayed in the antenna array region over the substrate, and bonded to the redistribution structure. The radio frequency front-end chips are respectively signal connected to the antenna electrodes. The radio frequency front-end chips are electrically connected to the beamforming chips.

### BRIEF DESCRIPTION OF THE DRAWINGS

FIG. 1 is a schematic top view of an antenna device according to an embodiment of the disclosure.

FIG. 2A is a perspective schematic view of a digital signal line of an antenna device according to an embodiment of the disclosure.

FIG. 2B is a perspective schematic view of a radio frequency signal line of an antenna device according to an embodiment of the disclosure.

FIG. 3 is a partial cross-sectional view of an antenna device according to an embodiment of the disclosure.

FIG. 4 is a schematic diagram of a bonding region of a circuit substrate according to an embodiment of the disclosure.

FIG. 5 is a cross-sectional view of a thin film transistor in a thin film circuit structure of an antenna device according to an embodiment of the disclosure.

FIG. 6 is a function block diagram of an antenna device according to an embodiment of the disclosure.

FIG. 7A is a circuit diagram of a buffer circuit of an antenna device according to an embodiment of the disclosure.

FIG. 7B is a circuit diagram of a buffer circuit of an antenna device according to an embodiment of the disclosure.

FIG. 7C is a circuit diagram of a buffer circuit of an antenna device according to an embodiment of the disclosure.

FIG. 8 is a schematic partial top view of an antenna device according to an embodiment of the disclosure.

FIG. 9 is a circuit schematic diagram of an antenna device according to an embodiment of the disclosure.

FIG. 10A is a schematic partial top view of an antenna device according to an embodiment of the disclosure.

FIG. 10B is a partial cross-sectional view of a buffer circuit chip of an antenna device 30 according to an embodiment of the disclosure.

FIG. 11 is a circuit schematic diagram of an antenna device according to an embodiment of the disclosure.

### DESCRIPTION OF THE EMBODIMENTS

In the accompanying drawings, the thickness of layers, films, panels, regions, and so forth are enlarged for clarity. It should be understood that when an element, such as a layer, a film, a region, or a substrate is referred to as being “on” or “connected to” another element, it can be directly on or connected to the another element, or an intermediate element may also be present. By contrast, when an element is referred to as being “directly on” or “directly connected to” another element, no intermediate element is present. As used herein, being “connected” may refer to a physical and/or electrical connection. Furthermore, being “electrically connected” may refer to the presence of other elements between the two elements.

It should be understood that the terms "first," "second," and "third" may be used to describe different elements, components, areas, layers and/or portions in the disclosure, but these elements, components, areas, layers and/or portions should not be limited by these terms. These terms are only used to distinguish the elements, components, areas, layer and/or portions from one another. Therefore, “first elements,” “components,” “areas,” “layers” and/or “portions” may be referred to as second elements, components, areas, layers and/or portions without departing from the scope of the inventive concept.

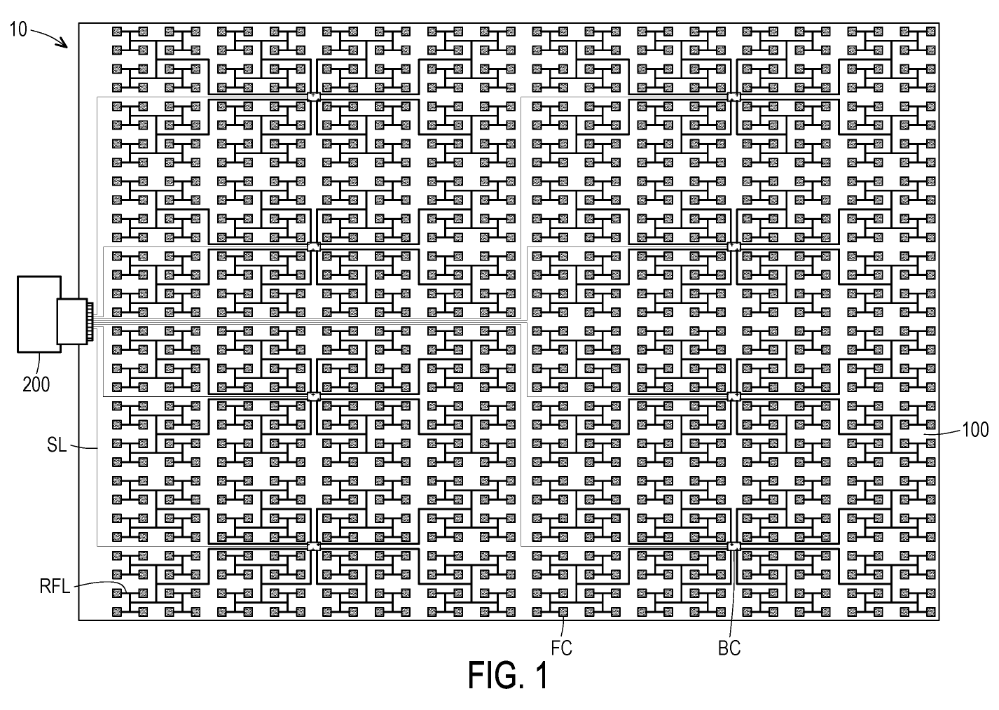

FIG. 1 is a schematic cross-sectional view of an antenna device 10 according to an embodiment of the disclosure. Please refer to FIG. 1. The antenna device 10 includes a circuit substrate 100, multiple beamforming chips BC, and multiple radio frequency front-end chips FC. The beamforming chips BC and the radio frequency front-end chips FC are bonded to the circuit substrate 100. In the embodiment, the antenna device 10 further includes an assembly circuit board 200. In some embodiments, the beamforming chip BC may also be referred to as a beamformer integrated circuit (BFIC). The radio frequency front-end chip FC may also be referred to as a radio frequency front-end integrated circuit (RF FEIC). In some embodiments, the antenna device 10 is a transparent antenna device. In some embodiments, the antenna device 10 is a vehicle antenna device and may be integrated with a vehicle window (such as a sunroof) and configured to receive a satellite signal (such as a low Earth orbit satellite signal).

In the embodiment, the beamforming chips BC and the radio frequency front-end chips FC are configured to perform a two-stage adjustment on a signal to reduce signal loss.

Specifically, a digital signal is transmitted between the beamforming chips BC and the assembly circuit board 200 through a digital signal line SL in the circuit substrate 100. In some embodiments, the digital signal on the digital signal line SL involves, for example, peripheral component interconnect express (PCIe) technology, serial advanced technology attachment (SATA) technology, universal serial bus (USB) technology, Ethernet technology, high-definition multimedia interface (HDMI) technology, low-voltage differential signaling (LVDS) technology, and other high-speed digital interface technologies. In some embodiments, a frequency of the digital signal on the digital signal line SL is less than 10GHz, or less than 1GHz.

In some embodiments, the signal input to the beamforming chips BC from the assembly circuit board 200 is a digital signal rather than an analog signal. Therefore, an up/down converter (UDC) in a peripheral region of the antenna device 10 may be omitted, thereby reducing a border size of the antenna device 10.

The beamforming chips BC convert the digital signal provided by the digital signal line SL into a radio frequency signal with a higher frequency (for example, a frequency greater than or equal to 10 GHz). Then, the radio frequency signal is transmitted to the radio frequency front-end chips FC from the beamforming chips BC through a radio frequency signal line RFL in the circuit substrate 100. In FIG. 1, the digital signal line SL is represented by a thin line, while the radio frequency signal line RFL is represented by a thick line.

In the embodiment, the beamforming chips BC and the radio frequency front-end chips FC are all arrayed in an antenna array region of the circuit substrate 100. Since the digital signal in the digital signal line SL is less likely to generate loss during transmission compared to the radio frequency signal, a thickness and a line width of the digital signal line SL may be smaller. In addition, generally, to decrease radio frequency signal loss, a shielding structure (not shown in FIG. 1) may be disposed around the radio frequency signal line RFL. The shielding structure is, for example, grounded. In the embodiment, since a signal line between the beamforming chips BC and the assembly circuit board 200 is the digital signal line SL rather than the radio frequency signal line RFL, the foregoing shielding structure may be omitted, further enhancing an aperture ratio of the device. In addition, in the embodiment, through the configuration of the radio frequency front-end chips FC, a quantity of the beamforming chips BC may be decreased (for example, a quantity of the beamforming chips BC is less than a quantity of antenna electrodes). Therefore, the beamforming chips BC with a higher cost may be saved, further decreasing the production cost of the antenna device.

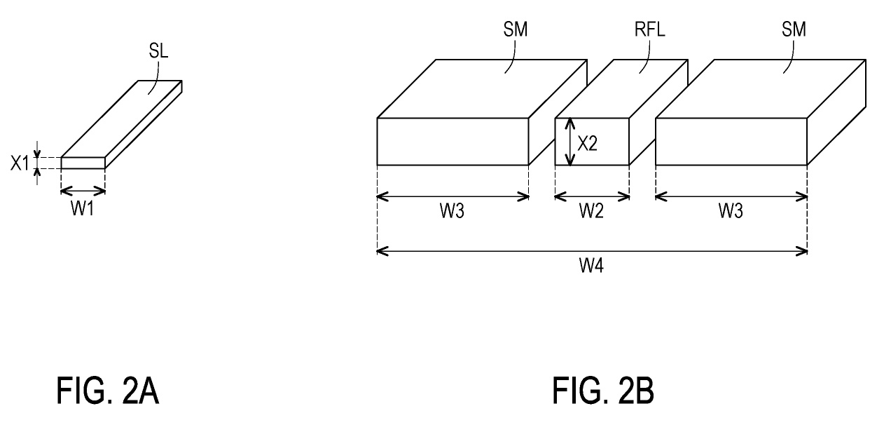

FIG. 2A is a perspective schematic view of a digital signal line of an antenna device according to an embodiment of the disclosure. FIG. 2B is a perspective schematic view of a radio frequency signal line of an antenna device according to an embodiment of the disclosure. For example, FIGS. 2A and 2B respectively show a portion of the digital signal line SL and a portion of the radio frequency signal line RFL in the antenna device 10 of FIG. 1. FIG. 2B further shows a shielding structure SM around the radio frequency signal lines RFL.

Please refer to FIGS. 2A and 2B. A thickness X1 of the digital signal line SL is less than 1 micron, for example, greater than 0.03 microns and less than 1 micron. In some embodiments, a width W1 of the digital signal line SL is 3 microns to 10 microns.

In some embodiments, a thickness X2 of the radio frequency signal line RFL is greater than the thickness X1 of the digital signal line SL. For example, the thickness X2 is 2 microns to 10 microns. In some embodiments, a width W2 of the radio frequency signal line RFL is 80 microns to 150 microns. A width W3 of the shielding structure SM is 160 microns to 300 microns. A total width W4 of the radio frequency signal line RFL together with the surrounding shielding structures SM is 400 microns to 750 microns.

In some embodiments, since the signal between the assembly circuit board and the thin film circuit structure is a digital signal rather than a radio frequency signal, there is no need to dispose the radio frequency signal line RFL between the assembly circuit board and the thin film circuit structure. In this way, in addition to decreasing the demand for the shielding structure SM, the digital signal line SL with the smaller width W1 may be used to transmit the signal, thereby significantly enhancing the aperture ratio (or transmittance) of the antenna device.

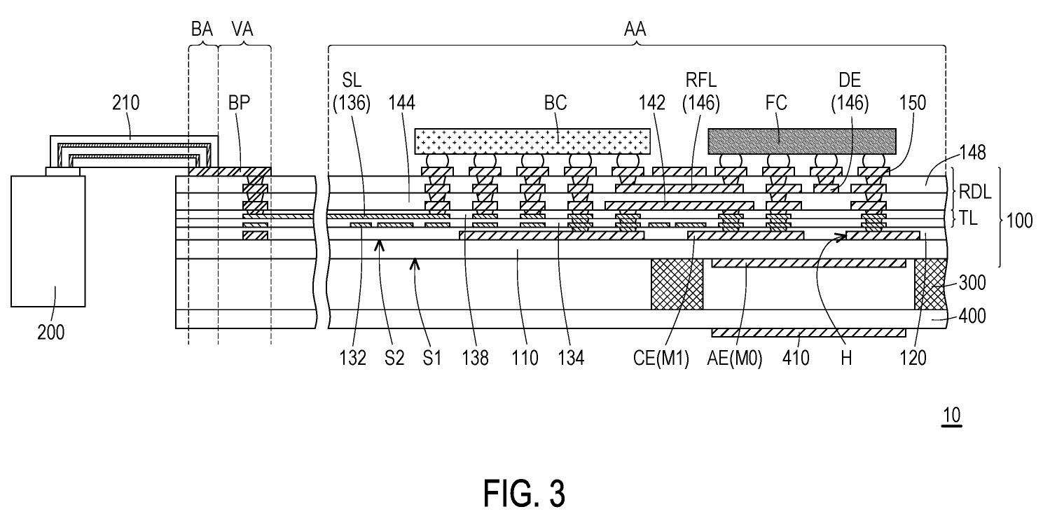

FIG. 3 is a partial cross-sectional view of an antenna device according to an embodiment of the disclosure. For example, FIG. 3 is a partial cross-sectional view of the antenna device 10 in FIG. 1. Please refer to FIG. 3. The antenna device 10 includes the circuit substrate 100, the beamforming chip BC, and the radio frequency front-end chip FC.

The circuit substrate 100 includes a substrate 110, multiple antenna electrodes AE, a thin film circuit structure TL, and a redistribution structure RDL.

The substrate 110 has a first surface S1 and a second surface S2 opposite to the first surface S1. In some embodiments, a material of the substrate 110 includes glass, quartz, organic polymer, or other suitable materials. In some embodiments, the substrate 110 is a transparent substrate. In some embodiments, a thickness of the substrate 110 is 500 microns to 1100 microns.

The antenna electrodes AE are arrayed in an antenna array region AA on the substrate 110. In the embodiment, a zeroth conductive layer M0 is disposed on the first surface S1 of the transparent substrate 110. The zeroth conductive layer M0 includes the antenna electrodes AE. In some embodiments, a thickness of the zeroth conductive layer M0 is 2 microns to 10 microns. In some embodiments, the antenna electrodes AE are configured for radiation or reception of a radio frequency signal.

The first conductive layer M1 is disposed on the second surface S2 of the substrate 110. The first conductive layer M1 includes a ground electrode CE. In the embodiment, the ground electrode CE has an opening H. The opening H overlaps the antenna electrode AE. In some embodiments, a thickness of the first conductive layer M1 is 2 microns to 10 microns. In some embodiments, the first conductive layer M1 serves as a shielding layer. For example, the ground electrode CE may be configured to shield a signal and decrease noise.

In some embodiments, a material of the zeroth conductive layer M0 and the first conductive layer M1 includes copper (Cu), aluminum (Al), gold (Au), silver (Ag), titanium (Ti), nickel (Ni), tungsten (W), conductive oxides (such as indium tin oxide or indium zinc oxide), or other suitable materials or a combination of the foregoing materials.

In some embodiments, a method of forming the zeroth conductive layer M0 and the first conductive layer M1 includes that a seed layer is first formed on the first surface S1 and the second surface S2 of the transparent substrate 110 through sputtering, electroless plating, or other suitable processes. Next, a metal layer is formed on the seed layer using an electroplating process. The seed layer and the metal layer may be patterned through lithography and an etching process to obtain the zeroth conductive layer M0 and the first conductive layer M1. In other embodiments, the seed layer may be omitted.

A buffer layer 120 is located on the transparent substrate 110 and the ground electrode CE. In some embodiments, the buffer layer 120 includes a transparent material, such as an organic material (such as polyimide, polyethylene terephthalate, or epoxy resin) or an inorganic material (such as silicon nitride or silicon oxide) or a combination of the foregoing materials. In some embodiments, since the thickness of the zeroth conductive layer M0 is 2 microns to 10 microns, to achieve the planarization effect, a thickness of the buffer layer 120 is preferably 2 microns to 15 microns, and the thickness of the buffer layer 120 is not less than a thickness of the ground electrode CE. For example, the thickness of the buffer layer 120 is 1.3 times the thickness of the ground electrode CE. To achieve this thickness to obtain the planarization effect, an organic material is preferably used for the buffer layer 120.

The thin film circuit structure TL is located on the substrate 110. In the embodiment, the thin film circuit structure TL is located over the buffer layer 120. In some embodiments, an overall thickness of the thin film circuit structure TL is less than 10 microns.

The thin film circuit structure TL includes a first thin film conductive layer 132 (or referred to as a second conductive layer), a first dielectric layer 134, a second thin film conductive layer 136 (or referred to as a third conductive layer), and a second dielectric layer 138 that are deposited in sequence. In some embodiments, a portion of the first thin film conductive layer 132 passes through the buffer layer 120 and is electrically connected to the first conductive layer M1. In some embodiments, a portion of the second thin film conductive layer 136 passes through the first dielectric layer 134 and is electrically connected to the first thin film conductive layer 132. In some embodiments, the thin film circuit structure TL may further include more conductive layers and dielectric layers. The disclosure does not limit a quantity of the conductive layers and the dielectric layers in the thin film circuit structure TL. In some embodiments, the thin film circuit structure TL may further include a semiconductor layer, allowing the thin film circuit structure TL to include a thin film transistor. However, the disclosure is not limited thereto. Through allowing the thin film circuit structure TL to include the thin film transistor, a portion of functional circuits may be disposed in the thin film circuit structure TL, thereby decreasing chip costs.

In some embodiments, one or more of the first thin film conductive layer 132 and the second thin film conductive layer 136 include the digital signal line SL. In some embodiments, various signal lines in the thin film circuit structure TL may be configured to transmit a control signal (such as a digital control signal) that operates various chips or circuits in the antenna device.

In some embodiments, a thickness of each of the first thin film conductive layer 132 and the second thin film conductive layer 136 is 0.01 microns to 0.05 microns. In some embodiments, a material of the first thin film conductive layer 132 and the second thin film conductive layer 136 includes copper (Cu), aluminum (Al), gold (Au), silver (Ag), titanium (Ti), nickel (Ni), tungsten (W), conductive oxide (such as indium tin oxide or indium zinc oxide) or other suitable materials or a combination of the foregoing materials. The first thin film conductive layer 132 and the second thin film conductive layer 136 each have a single-layer structure or a multi-layer structure. For example, the first thin film conductive layer 132 and the second thin film conductive layer 136 each have a molybdenum/aluminum/molybdenum stacked structure, a titanium/aluminum/titanium stacked structure, or a stacked structure composed of other conductive materials.

In some embodiments, a thickness of each of the first dielectric layer 134 and the second dielectric layer 138 is 0.5 microns to 1 micron. In some embodiments, a material of the first dielectric layer 134 and the second dielectric layer 138 includes an organic polymer (such as polyimide, or polyethylene terephthalate) or an inorganic material (such as silicon oxide, silicon nitride, silicon oxynitride, aluminum oxide, zirconium oxide, hafnium oxide or other suitable materials or a combination of the foregoing materials).

The redistribution structure RDL is located on the thin film circuit structure TL. In the embodiment, the redistribution structure RDL is located on the second dielectric layer 138.

The redistribution structure RDL includes a first redistribution layer 142 (or referred to as a fourth conductive layer), an insulating layer 144, a second redistribution layer 146 (or referred to as a fifth conductive layer), an insulating layer 148, and a third redistribution layer 150 (or referred to as a sixth conductive layer) that are deposited in sequence. In some embodiments, a portion of the first redistribution layer 142 passes through the second dielectric layer 138 and is electrically connected to the second thin film conductive layer 136 of the thin film circuit structure TL. In some embodiments, the redistribution structure RDL may include more or fewer conductive layers and insulating layers. The disclosure does not limit a quantity of the conductive layers and the insulating layers in the redistribution structure RDL.

In some embodiments, at least one of the first redistribution layer 142, the second redistribution layer 146, and the third redistribution layer 150 includes various signal lines and various shielding structures. For example, the signal lines in the redistribution structure RDL include, for example, the radio frequency signal line RFL and a power signal line (not shown in the figure), etc. In some embodiments, the first redistribution layer 142 may serve as a shielding layer. For example, the first redistribution layer 142 may include a shielding structure configured to shield a signal. The shielding structure may be grounded and disposed around the radio frequency signal line to decrease the generation of interference. In some embodiments, the third redistribution layer 150 includes a pad structure that is configured to be bonded with various external devices, such as chips, surface-mount devices (SMD), or flexible circuit substrates.

In some embodiments, a thickness of each of the first redistribution layer 142, the second redistribution layer 146, and the third redistribution layer 150 is 2 microns to 10 microns. In some embodiments, a material of the first redistribution layer 142, the second redistribution layer 146, and the third redistribution layer 150 includes copper (Cu), aluminum (Al), gold (Au), silver (Ag), titanium (Ti), nickel (Ni), tungsten (W), conductive oxides (such as indium tin oxide or indium zinc oxide) or other suitable materials or a combination of the foregoing materials. In some embodiments, each of the first redistribution layer 142, the second redistribution layer 146, and the third redistribution layer 150 includes a seed layer and a metal layer formed thereon. The seed layer is formed by, for example, sputtering, electroless plating, or other suitable methods. The metal layer is formed by electroplating. In some embodiments, the seed layer may be omitted.

In some embodiments, a thickness of each of the insulating layers 144 and 148 is 10 microns to 60 microns. In some embodiments, a material of the insulating layers 144 and 148 includes an organic material (such as polyimide, polyethylene terephthalate, or epoxy resin) or an inorganic material (such as silicon nitride or silicon oxide) or a combination of the foregoing materials. In some embodiments, a method of forming the insulating layers 144 and 148 includes that a dry film is adhered on the redistribution layer, or a liquid organic material (such as a liquid polyimide (PI) material) is coated on the redistribution layer.

In some embodiments, the insulating layers 144 and 148 have a high transmittance and a low dissipation factor (Df). For example, the transmittance of the insulating layers 144 and 148 for light with wavelengths of 400 nm to 800 nm is greater than or equal to 90%. In some embodiments, the dielectric constant (Dk) of the insulating layers 144 and 148 is lower than 4, and the dissipation factor is lower than 0.004.

The beamforming chips BC are arrayed in the antenna array region AA on the substrate 110, and bonded to the redistribution structure RDL. The radio frequency front-end chips FC are arrayed in the antenna array region AA on the substrate 110, and bonded to the redistribution structure RDL. For example, the beamforming chips BC and the radio frequency front-end chips FC are bonded to the third redistribution layer 150 of the redistribution structure RDL.

In some embodiments, the multiple radio frequency front-end chips FC are respectively signal connected to the antenna electrodes AE. In the embodiment, the redistribution structure RDL includes a driving electrode DE that is electrically connected to the radio frequency front-end chips FC. The driving electrode DE overlaps the openings H of the ground electrode CE, and is signal bonded to the antenna electrode AE through radiation. In other embodiments, the substrate 110 includes a conductive via that is connected to the antenna electrodes AE. The radio frequency front-end chip FC is electrically connected to the antenna electrode AE directly through the conductive via.

The radio frequency front-end chips FC are electrically connected to the beamforming chips BC. In some embodiments, the beamforming chips BC are electrically connected to the digital signal line SL in the thin film circuit structure TL. The radio frequency front-end chips FC are electrically connected to the beamforming chips BC through the multiple radio frequency signal lines RFL in the redistribution structure RDL.

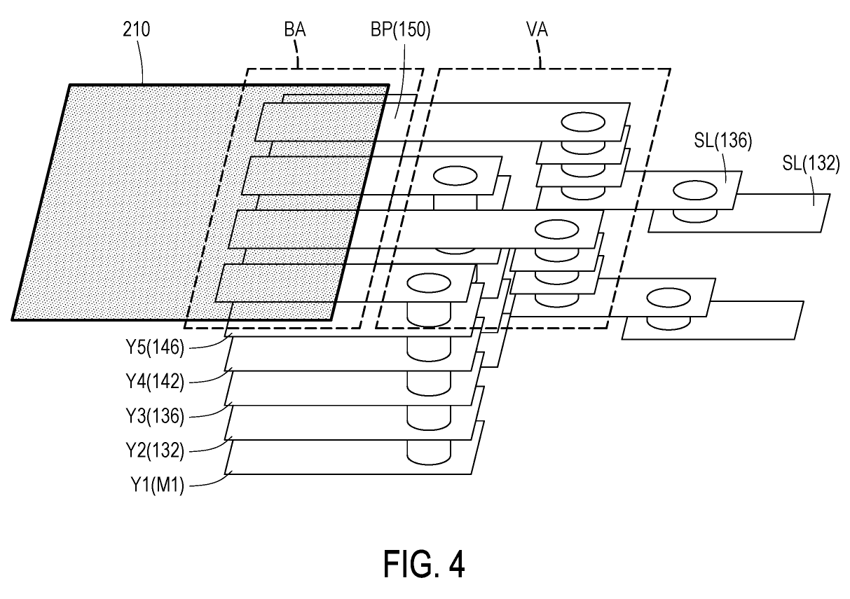

The assembly circuit board 200 is electrically connected to the beamforming chips BC. Please refer to FIGS. 3 and 4. The assembly circuit board 200 is bonded to a bonding region BA of the circuit substrate 100 through a flexible circuit board 210. In some embodiments, the redistribution structure RDL includes multiple pads BP in the bonding region BA. To enhance the flatness of the pads BP, one or more support structures Y1 to Y5 are disposed below the pads BP to enhance the yield of the bonding process.

In some embodiments, the support structures Y1 to Y5 respectively belong to the first conductive layer M1, the first thin film conductive layer 132, the second thin film conductive layer 136, the first redistribution layer 142, and the second redistribution layer 146. The pads BP belong to the third redistribution layer 150. In some embodiments, at least a portion of the support structures Y1 to Y5 is grounded. In some embodiments, a portion of the pads BP is extended to a transfer line region VA from the bonding region BA, and is connected to the digital signal line SL below through one or more conductive vias in the transfer line region VA.

Returning to FIG. 3, in some embodiments, the antenna device 10 further includes a support structure 300, an opposite substrate 400, and an opposite electrode 410. The support structure 300 is disposed on the first surface S1 of the substrate 110, and is located between the substrate 110 and the opposite substrate 400, so that the substrate 110 and the opposite substrate 400 may be separated. The opposite electrode 410 is disposed on the opposite substrate 400, and is signal connected to the antenna electrode AE through radiation. The opposite electrode 410 overlaps, for example, the antenna electrode AE.

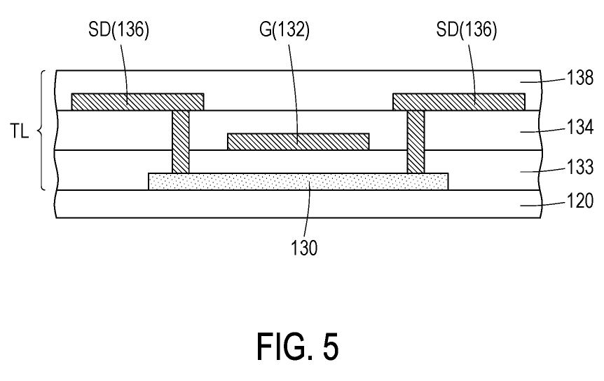

FIG. 5 is a cross-sectional view of a thin film transistor in the thin film circuit structure TL of an antenna device according to an embodiment of the disclosure. For example, the thin film circuit structure TL in FIG. 3 may further include a semiconductor layer 130 and a third dielectric layer 133. The semiconductor layer 130 and the third dielectric layer 133 are located on the buffer layer 120. The first thin film conductive layer 132 includes a gate G, and is located on the third dielectric layer 133. The first dielectric layer 134 is located on the third dielectric layer 133 and the gate G. The second thin film conductive layer 136 includes a source/drain SD. The source/drain SD is located on the first dielectric layer 134, and electrically connected to the semiconductor layer 130. The source/drain SD, the gate G, and the semiconductor layer 130 commonly form a thin film transistor. In the embodiment, the thin film transistor in the thin film circuit structure TL is a top-gate type thin film transistor. However, the disclosure is not limited thereto. In other embodiments, the thin film transistor in the thin film circuit structure TL is a bottom-gate type thin film transistor, a dual-gate type thin film transistor, or other types of thin film transistors.

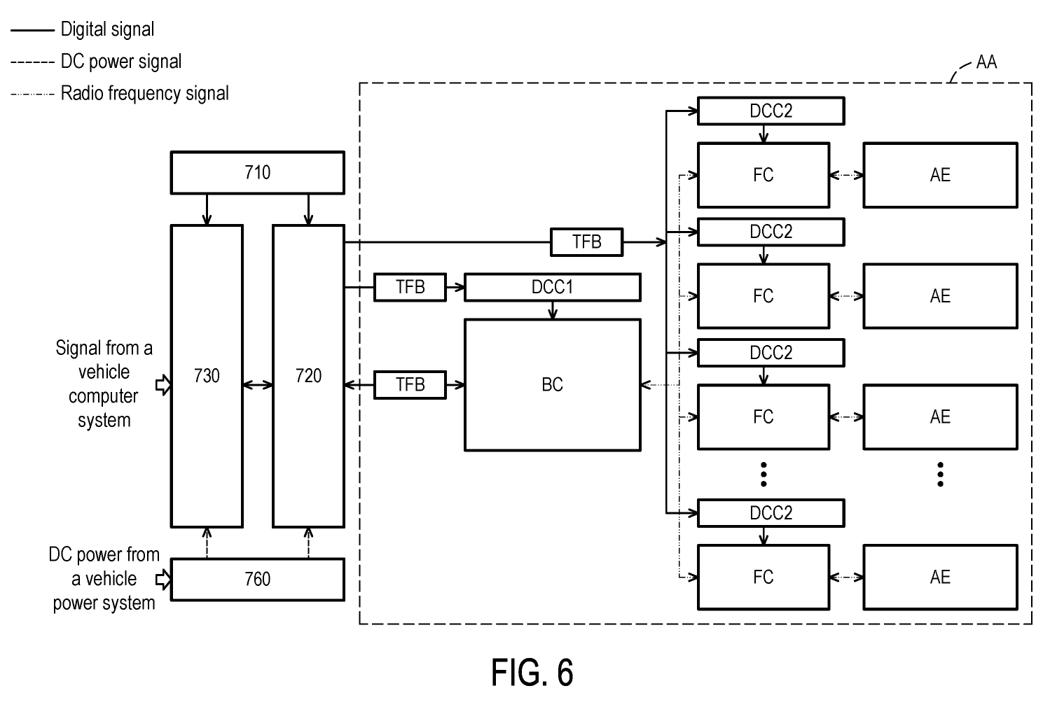

FIG. 6 is a function block diagram of an antenna device according to an embodiment of the disclosure. For example, FIG. 6 is a function block diagram of the antenna device 10 in FIG. 3. Please refer to FIGS. 3 and 6. A modulator/demodulator (MODEM) 730, a field-programmable gate array (FPGA) 720, a power module 760, a global positioning system (GPS)/ G-sensor module 710, and other elements may be disposed in one or more chips, and may be, for example, disposed in the assembly circuit board 200 in FIG. 3.

In some embodiments, since the antenna device is disposed on a vehicle, a vehicle computer system may provide a signal to the modulator/demodulator module 730. A vehicle power system may provide a DC power to the power module 760.

A digital signal (or a data/circuit control signal) is transmitted between the global positioning system/G-sensor module 710 and the field programmable gate array module 720, between the global positioning system/ G-sensor 710 and the modulator/demodulator module 730, and between the field programmable gate array module 720 and the modulator/demodulator module 730.

The digital signal is transmitted to the beamforming chip BC, the radio frequency front-end chips FC, a first digital signal control circuit DCC1, and second digital signal control circuits DCC2 in the antenna array region AA from the field programmable gate array module 720.

The first digital signal control circuit DCC1 and the second digital signal control circuits DCC2 are, for example, disposed in the thin film circuit structure TL of the antenna device (omitted in FIG. 3). The first digital signal control circuit DCC1 and the second digital signal control circuits DCC2 are respectively configured to control the signal provided to the beamforming chip BC and the radio frequency front-end chips FC. In some embodiments, the first digital signal control circuit DCC1 and the second digital signal control circuits DCC2 each include a memory circuit and multiple switching elements (such as thin film transistors). The memory circuits and the switching elements are all disposed in the thin film circuit structure TL.

In some embodiments, the thin film circuit structure TL includes the multiple first digital signal control circuits DCC1 and the multiple beamforming chips BC. The first digital signal control circuits DCC1 are respectively electrically connected to the beamforming chips BC. For example, the first digital signal control circuit DCC1 is electrically connected to the beamforming chip BC through the digital signal line SL in the thin film circuit structure TL.

In some embodiments, the thin film circuit structure TL includes the multiple second digital signal control circuits DCC2 and the multiple radio frequency front-end chips FC. The second digital signal control circuits DCC2 are respectively electrically connected to the radio frequency front-end chips FC. For example, the second digital signal control circuit DCC2 is electrically connected to the radio frequency front-end chip FC through the digital signal line SL in the thin film circuit structure TL.

In some embodiments, the thin film circuit structure TL includes multiple buffer circuits TFB (omitted in FIG. 3). The buffer circuit TFB includes multiple thin film transistors and is used to improve the problem of signal delay (such as gate delay time) caused by inconsistent lengths of the digital signal lines SL.

In some embodiments, at least one of the beamforming chips BC is electrically connected to at least one of the buffer circuits TFB. At least one of the first digital signal control circuits DCC1 is electrically connected to at least one of the buffer circuits TFB. At least one of the second digital signal control circuits DCC2 is electrically connected to at least one of the buffer circuits TFB.

After the beamforming chip BC receives a frequency digital signal from the assembly circuit board 200, the digital signal (for example, frequency less than 10GHz) is converted into a radio frequency signal with a higher frequency (for example, frequency greater than or equal to 10GHz), and is transmitted to the radio frequency front-end chips FC. Next, the radio frequency front-end chips FC process the radio frequency signal and further transmits the processed radio frequency signal to the antenna electrodes AE. Conversely, after the antenna electrodes AE receive the radio frequency signal, the radio frequency signal is transmitted to the radio frequency front-end chips FC for processing, and then transmitted to the beamforming chip BC from the radio frequency front-end chips FC, and converted into a digital signal with a lower frequency, and finally transmitted to the assembly circuit board 200 from the beamforming chip BC.

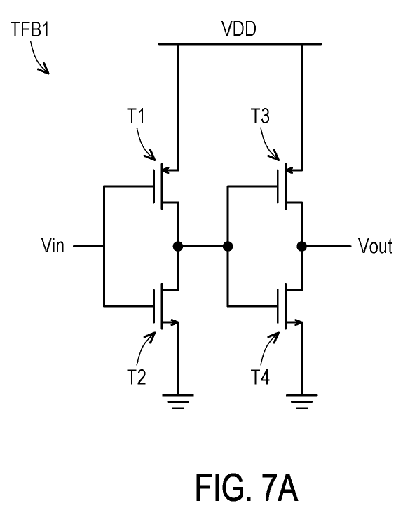

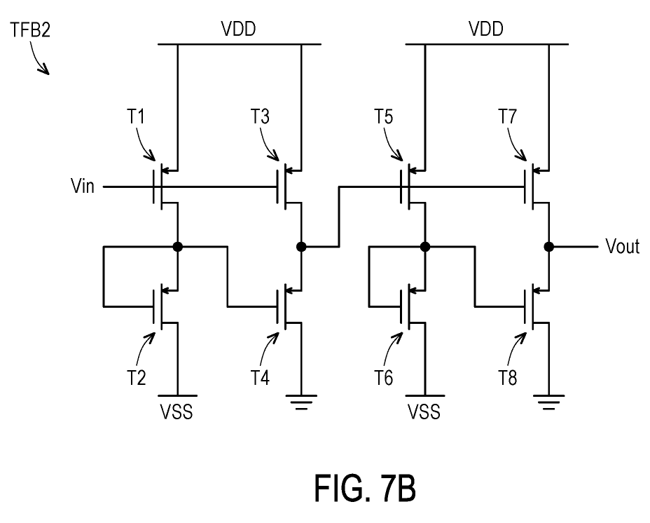

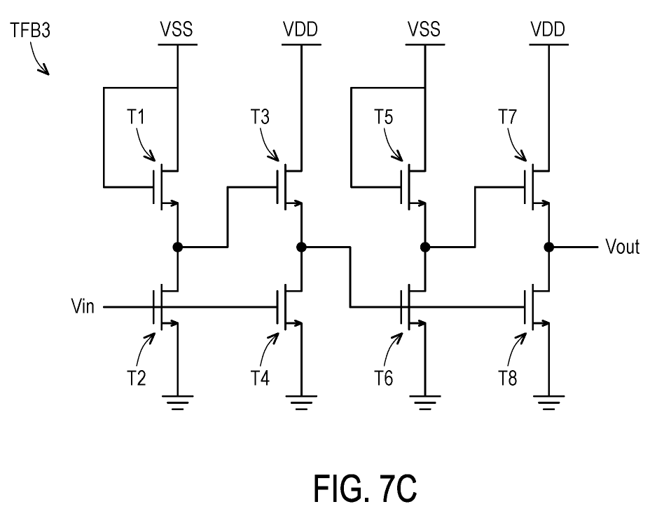

FIG. 7A is a circuit diagram of a buffer circuit TFB1 according to an embodiment of the disclosure. In the embodiment of FIG. 7A, four thin film transistors T1 to T4 are compatible with each other to form the buffer circuit TFB1. A structure of the thin film transistors T1 to T4 may be similar to the structure shown in FIG. 5, or may also be other types of thin film transistors.

Gates of the thin film transistors T1 and T2 are connected to a signal input terminal Vᵢₙ. One source/drain of each of the thin film transistors T1 and T3 is connected to a first operating voltage VDD. One source/drain of each of the thin film transistors T2 and T4 is grounded.

The other source/drain of the thin film transistor T1 is connected to the other source/drain of the thin film transistor T2, a gate of the thin film transistor T3, and a gate of the thin film transistor T4.

The other source/drain of each of the thin film transistors T3 and T4 is connected to a signal output terminal Vₒᵤₜ.

In FIG. 7A, the buffer circuit TFB1 including the four thin film transistors T1 to T4 is taken as an example. However, the disclosure is not limited thereto. The buffer circuit may also include other quantities of thin film transistors.

FIG. 7B is a circuit diagram of a buffer circuit TFB2 according to an embodiment of the disclosure. In the embodiment of FIG. 7B, eight thin film transistors T1 to T8 are compatible with each other to form the buffer circuit TFB2. A structure of the thin film transistors T1 to T8 may be similar to the structure shown in FIG. 5, or may also be other types of thin film transistors.

Gates of the thin film transistors T1 and T3 are connected to the signal input terminal Vᵢₙ. One source/drain of each of the thin film transistors T1, T3, T5, and T7 is connected to the first operating voltage VDD. One source/drain of each of the thin film transistors T2 and T6 is connected to a second operating voltage VSS. One source/drain of each of the thin film transistors T4 and T8 is grounded.

The other source/drain of the thin film transistor T1 is connected to a gate of the thin film transistor T2, the other source/drain of the thin film transistor T2, and a gate of the thin film transistor T4. The other source/drain of the thin film transistor T3 is connected to a gate of the thin film transistor T5, a gate of the thin film transistor T7, and the other source/drain of the thin film transistor T4. The other source/drain of the thin film transistor T5 is connected to a gate of the thin film transistor T6, the other source/drain of the thin film transistor T6, and a gate of the thin film transistor T8.

The other source/drain of the thin film transistor T7 and the other source/drain of the thin film transistor T8 are connected to the signal output terminal Vₒᵤₜ.

FIG. 7C is a circuit diagram of a buffer circuit TFB3 according to an embodiment of the disclosure. In the embodiment of FIG. 7C, eight thin film transistors T1 to T8 are compatible with each other to form the buffer circuit TFB3. A structure of the thin film transistors T1 to T8 may be similar to the structure shown in FIG. 5, or may also be other types of thin film transistors.

Gates of the thin film transistors T2 and T4 are connected to the signal input terminal Vᵢₙ. One source/drain of each of the thin film transistors T2, T4, T6, and T8 is grounded. One source/drain of each of the thin film transistors T3 and T7 is connected to the first operating voltage VDD. One source/drain and a gate of each of the thin film transistors T1 and T5 are connected to the second operating voltage VSS.

The other source/drain of the thin film transistor T1 is connected to the other source/drain of the thin film transistor T2 and a gate of the thin film transistor T3. The other source/drain of the thin film transistor T3 is connected to a gate of the thin film transistor T6, a gate of the thin film transistor T8, and the other source/drain of the thin film transistor T4. The other source/drain of the thin film transistor T5 is connected to a gate of the thin film transistor T7 and the other source/drain of the thin film transistor T6.

The other source/drain of the thin film transistor T7 and the other source/drain of the thin film transistor T8 are connected to the signal output terminal Vₒᵤₜ.

In various embodiments of the disclosure, the buffer circuit in the thin film circuit structure may be represented by one or more of the buffer circuit TFB1 in FIG. 7A, the buffer circuit TFB2 in FIG. 7B, and the buffer circuit TFB3 in FIG. 7C. In addition, other types of buffer circuits may also be suitable.

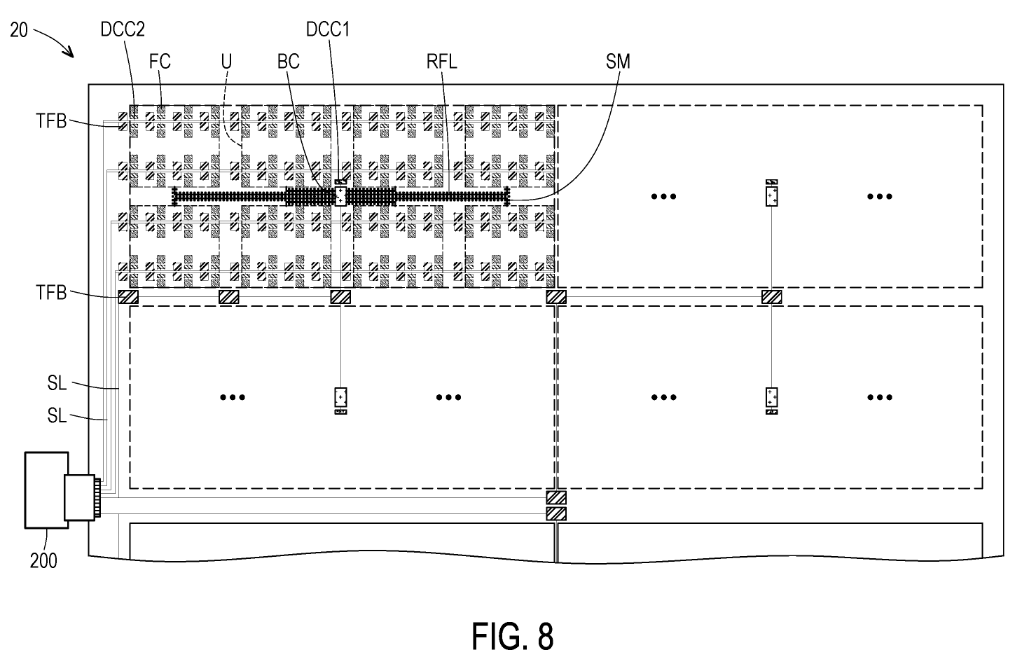

FIG. 8 is a schematic partial top view of an antenna device 20 according to an embodiment of the disclosure. It should be noted that the various signal lines in FIG. 8 are merely for illustration. The antenna device 20 may include more other signal lines.

Please refer to FIG. 8. The beamforming chips BC are electrically connected to the assembly circuit board 200 through the digital signal lines SL. The one or more buffer circuits TFB are included between the beamforming chip BC and the assembly circuit board 200. The buffer circuits TFB are electrically connected to the assembly circuit board 200 and the beamforming chips BC through the digital signal lines SL.

Each of the beamforming chips BC is electrically connected to multiple antenna unit groups U located therearound through the radio frequency signal lines RFL. Each of the antenna unit groups U includes the multiple radio frequency front-end chips FC and multiple antenna electrodes corresponding thereto (not shown in FIG. 8). For brevity, FIG. 8 omits line segments where the radio frequency signal lines RFL enter the antenna unit groups U and are connected to each of the radio frequency front-end chips FC.

In the embodiment, each of the beamforming chips BC is electrically connected to the corresponding first digital signal control circuit DCC1. Each of the radio frequency front-end chips FC is electrically connected to the corresponding second digital signal control circuit DCC2.

FIG. 8 shows the multiple buffer circuits TFB. A configuration level of the buffer circuits TFB is determined by a long-distance trace (that is, a trace distance between the assembly circuit board 200 and the beamforming chip BC, the first digital signal control circuit DCC1, or the second digital signal control circuit DCC2 that is farthest therefrom). For example, a quantity of the buffer circuits TFB electrically connected to the beamforming chip BC closest to the assembly circuit board 200 is equal to a quantity of the buffer circuits TFB electrically connected to the beamforming chip BC farthest from the assembly circuit board 200 to ensure that signals transmitted to different beamforming chips BC have a same gate delay time. The buffer circuit TFB is configured, for example, at a trace turning point.

In the embodiment, the multiple shielding structures SM are included around each of the radio frequency signal lines RFL. For example, the shielding structures SM are distributed around the radio frequency signal lines RFL in a form of conductive via. In some embodiments, the radio frequency signal lines RFL and the shielding structures SM are both disposed in a redistribution structure.

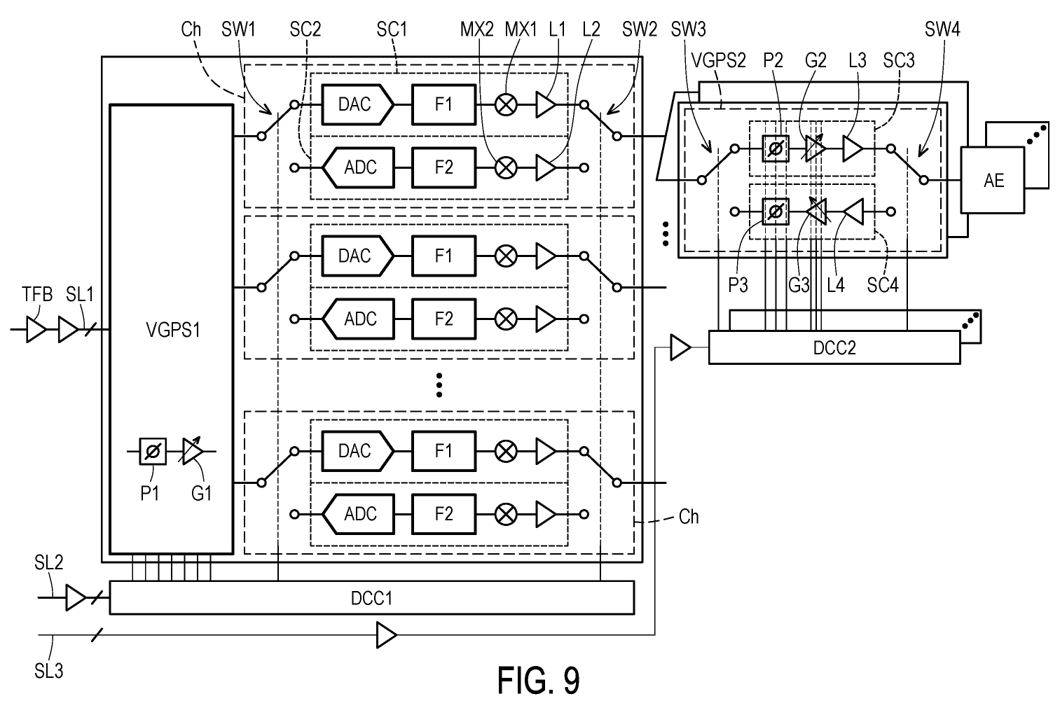

FIG. 9 is a circuit schematic diagram of the antenna device 20 according to an embodiment of the disclosure. It must be noted here that the embodiment of FIG. 9 uses the reference numerals and a part of the content of the embodiment of FIG. 8. Same or similar reference numerals are used to represent same or similar elements, and the description of the same technical content is omitted. The aforementioned embodiment may be referred to for the descriptions of the omitted parts, and descriptions of those parts will not be repeated in the following embodiments.

Please refer to FIG. 9. Each of the beamforming chips BC includes multiple circuit channels Ch and a first variable gain amplifier and phase adjuster module VGPS1 electrically connected to the circuit channels Ch. In some embodiments, the first variable gain amplifier and phase adjuster module VGPS1 includes a phase adjuster P1 and a gain adjuster G1.

In some embodiments, the beamforming chip BC includes multiple digital-to-analog converters DAC, multiple analog-to-digital converters ADC, multiple first filters F1, multiple first mixers MX1, multiple amplifiers L1, multiple second filters F2, multiple second mixers MX2, and multiple amplifiers L2. The digital-to-analog converters DAC, the first filters F1, the first mixers MX1, and the first amplifiers L1 form multiple first sub-circuits SC1. Each of the first sub-circuits SC1 includes a corresponding one among the digital-to-analog converters DAC, a corresponding one among the first filters F1, a corresponding one among the first mixers MX1, and a corresponding one among the amplifiers L1. The analog-to-digital converters ADC, the second filters F2, the second mixers MX2, and the amplifiers L2 form multiple second sub-circuits SC2. Each of the second sub-circuit SC2 includes a corresponding one among the analog-to-digital converters ADC, a corresponding one among the second filters F2, a corresponding one among the second mixers MX2, and a corresponding one among the amplifiers L2.

The beamforming chip BC further includes multiple first switching elements SW1 and multiple second switching elements SW2. Each of the first switching elements SW1 is electrically connected to a corresponding one among the first sub-circuits SC1, a corresponding one among the second sub-circuits SC2, and a corresponding one among the second switching elements SW2. Each of the first switching elements SW1 is configured to switch between a corresponding one among the digital-to-analog converters DAC and the corresponding one among the analog-to-digital converters ADC. Each of the second switching elements SW2 is configured to switch between the amplifier L1 and the amplifier L2.

The multiple circuit channels Ch each include a corresponding one among the first switching elements SW1, a corresponding one among the first sub-circuits SC1, a corresponding one among the second sub-circuits SC2, and a corresponding one among the second switching elements SW2. The first variable gain amplifier and phase adjuster module VGPS1 is electrically connected to the first switching element SW1 of the circuit channels Ch. The second switching element SW2 of each of the circuit channels Ch is electrically connected to the at least one corresponding radio frequency front-end chip FC. In other words, each of the circuit channels Ch is electrically connected to the at least one corresponding radio frequency front-end chip FC and the first variable gain amplifier and phase adjuster module VGPS1.

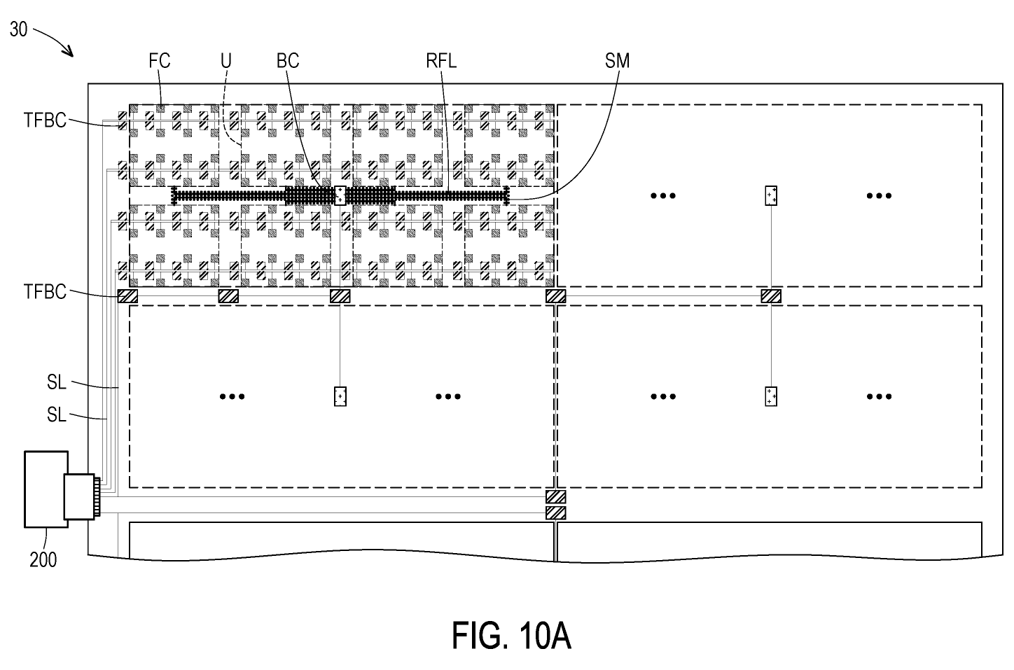

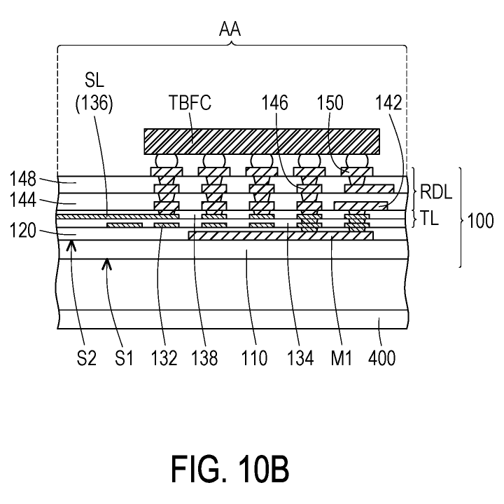

In the embodiments of FIGS. 9 and 10, each of the beamforming chips BC includes eight circuit channels Ch. However, the disclosure is not limited thereto. A quantity of the circuit channels Ch in the beamforming chip BC may be adjusted according to needs. Furthermore, although in the embodiments of FIGS. 9 and 10 each of the circuit channels Ch is electrically connected to sixteen radio frequency front-end chips FC. However, the disclosure is not limited thereto. A quantity of the radio frequency front-end chips FC connected to one circuit channel Ch may be adjusted according to needs.

The radio frequency front-end chip FC includes a second variable gain amplifier and phase adjuster module VGPS2. The second variable gain amplifier and phase adjuster module VGPS2 includes a third sub-circuit SC3, a fourth sub-circuit SC4, a third switching element SW3, and a fourth switching element SW4. The third sub-circuit SC3 includes a phase adjuster P2, a gain adjuster G2, and an amplifier L3. The fourth sub-circuit SC4 includes a phase adjuster P3, a gain adjuster G3, and an amplifier L4.

The third switching element SW3 is electrically connected to the third sub-circuit SC3 and the fourth sub-circuit SC4, and configured to switch between the phase adjuster P2 and the phase adjuster P3. The fourth switching element SW4 is electrically connected to the third sub-circuit SC3 and the fourth sub-circuit SC4, and configured to switch between the amplifier L3 and the amplifier L4. The beamforming chip BC is electrically connected to the third switching elements SW3 of the multiple radio frequency front-end chips FC. The fourth switching element SW4 of each of the radio frequency front-end chips FC is electrically connected to one corresponding antenna electrode AE. In other words, in the embodiment, each of the beamforming chips BC is electrically connected to the multiple antenna electrodes AE.

In the embodiment, a digital signal line SL1 provides a digital signal to the beamforming chip BC for a first gain and phase adjustment. For example, after the signal passes through the beamforming chip BC, an antenna gain is X₁₋₁dB, and a phase corresponding to the gain position is Y₁₋₁ degrees. Next, a radio frequency signal is further transmitted to the radio frequency front-end chip FC for a second gain and phase adjustment. For example, after the signal passes through the radio frequency front-end chip FC, the antenna gain is X₁₋₁+X₁₋₂ dB, and the phase corresponding to the gain position is Y₁₋₁+Y₁₋₂ degrees. In some embodiments, the multiple digital signal lines SL1 are connected to the beamforming chip BC.

In the embodiment, one beamforming chip BC is controlled by one first digital signal control circuit DCC1. A digital signal line SL2 inputs a control signal to the first digital signal control circuit DCC1. The first digital signal control circuit DCC1 is configured to control the first variable gain amplifier and phase adjuster module VGPS1 in the beamforming chip BC, a switching of the first switching element SW1, and a switching of the second switching element SW2. In some embodiments, through the switching of the first switching element SW1 and the switching of the second switching element SW2, the antenna device 20 may switch between a transmission mode (TX) and a reception mode (RX). In some embodiments, the multiple digital signal lines SL2 are connected to the first digital signal control circuit DCC1.

Similarly, one radio frequency front-end chip FC is controlled by one second digital signal control circuit DCC2. A digital signal line SL3 inputs a control signal to the second digital signal control circuit DCC2. The second digital signal control circuit DCC2 is configured to control the second variable gain amplifier and phase adjuster module VGPS2 in the radio frequency front-end chip FC, a switching of the third switching element SW3, and a switching of the fourth switching element SW4. In some embodiments, through the switching of the third switching element SW3 and the switching of the fourth switching element SW4, the antenna device 20 may switch between the transmission mode (TX) and the reception mode (RX). In some embodiments, the multiple digital signal lines SL3 are connected to the second digital signal control circuit DCC2.

In the embodiment, the beamforming chip BC and the radio frequency front-end chip FC are respectively controlled through the first digital signal control circuit DCC1 and the second digital signal control circuit DCC2 disposed in the thin film circuit structure. Compared to using a serial peripheral interface (SPI) circuit in the beamforming chip BC and the radio frequency front-end chip FC for operation, a faster signal transmission speed may be achieved.

In the embodiment, the buffer circuit TFB in the thin film circuit structure may be configured to supplement signal integrity and reduce the problem of signal delay caused by inconsistent signal line lengths. The buffer circuit TFB is arranged before the signal lines enter the beamforming chip BC and/or the radio frequency front-end chip FC, and is at a middle position of the signal lines.

FIG. 10A is a schematic partial top view of an antenna device 30 according to an embodiment of the disclosure. FIG. 10B is a partial cross-sectional view of a buffer circuit chip TFBC of the antenna device 30 according to an embodiment of the disclosure. It must be noted here that the embodiments of FIGS. 10A and 10B use the reference numerals and a part of the content of the embodiment of FIG. 8. Same or similar reference numerals are used to represent same or similar elements, and the description of the same technical content is omitted. The aforementioned embodiment may be referred to for the descriptions of the omitted parts, and descriptions of those parts will not be repeated in the following embodiments.

The antenna device 30 in FIGS. 10A and 10B is similar to the antenna device 20 in FIG. 8, where the difference is that: in the antenna device 30 of FIGS. 10A and 10B, the thin film circuit structure TL does not include the buffer circuit TFB. Instead, the buffer circuit chips TFBC are arrayed in the antenna array region AA on the substrate 110, and bonded to the redistribution structure RDL. At least one of the beamforming chips BC is electrically connected to at least one of the buffer circuit chips TFBC. In some embodiments, at least one of the radio frequency front-end chips FC is electrically connected to at least one of the buffer circuit chips TFBC.

In the embodiment, the buffer circuit chip TFBC may be configured to supplement signal integrity and reduce the problem of signal delay caused by inconsistent signal line lengths. The buffer circuit chip TFBC is arranged before the signal lines enter the beamforming chip BC and/or the radio frequency front-end chip FC, and is at a middle position of the signal lines.

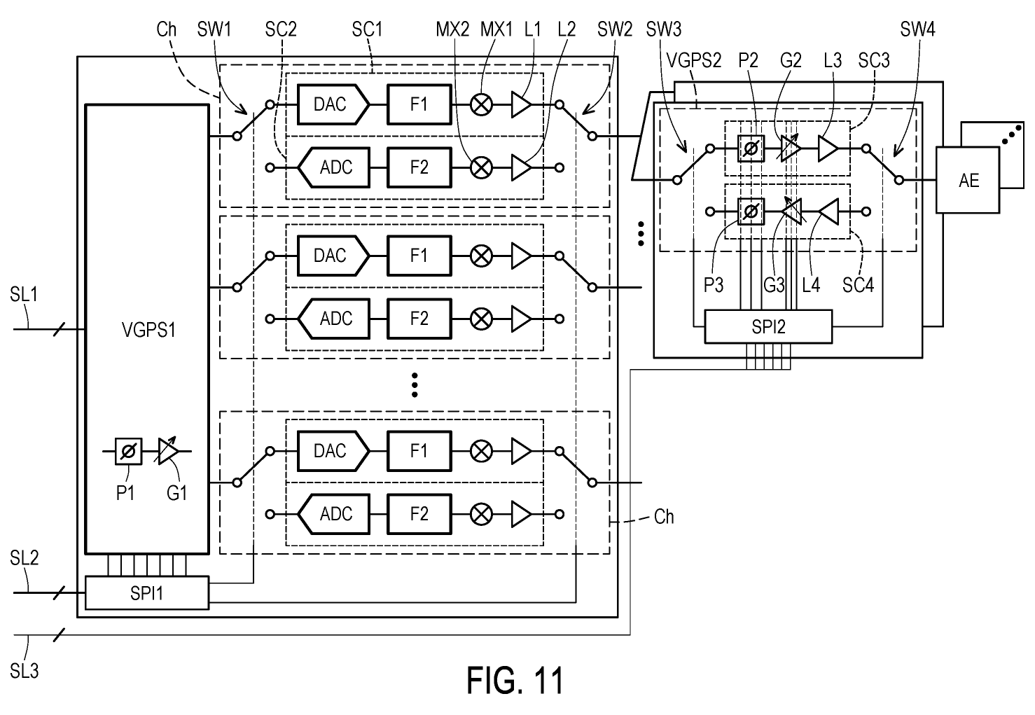

FIG. 11 is a circuit schematic diagram of the antenna device 30 according to an embodiment of the disclosure. It must be noted here that the embodiment of FIG. 11 uses the reference numerals and a part of the content of the embodiments of FIGS. 10A and 10B. Same or similar reference numerals are used to represent same or similar elements, and the description of the same technical content is omitted. The aforementioned embodiment may be referred to for the descriptions of the omitted parts, and descriptions of those parts will not be repeated in the following embodiments.

Please refer to FIG. 11. In the embodiment, the thin film circuit structure does not include the first digital signal control circuit DCC1 and the second digital signal control circuit DCC2. The beamforming chip BC and the radio frequency front-end chip FC respectively further include a first serial peripheral interface circuit SPI1 and a second serial peripheral interface circuit SPI2.

The first serial peripheral interface circuit SPI1 is electrically connected to the first variable gain amplifier and phase adjuster module VGPS1. The beamforming chip BC controls the first variable gain amplifier and phase adjuster module VGPS1, a switching of the first switching element SW1, and a switching of the second switching element SW2 through the first serial peripheral interface circuit SPI1 disposed therein. Similarly, the second serial peripheral interface circuit SPI2 is electrically connected to the second variable gain amplifier and phase adjuster module VGPS2. The radio frequency front-end chip FC controls the second variable gain amplifier and phase adjuster module VGPS2, a switching of the third switching element SW3, and a switching of the fourth switching element SW4 through the second serial peripheral interface circuit SPI2.

In summary, in the antenna device of the disclosure, the beamforming chips and the radio frequency front-end chips are configured to perform a two-stage adjustment on a signal to reduce signal loss. In addition, since the signal between the assembly circuit board and the thin film circuit structure is a digital signal rather than a radio frequency signal, signal loss during transmission can be decreased.

What is claimed is:

1. An antenna device, comprising:
a circuit substrate, comprising:
a substrate;
a plurality of antenna electrodes, arrayed in an antenna array region over the substrate;
a thin film circuit structure, located over the substrate; and
a redistribution structure, located over the thin film circuit structure;
a plurality of beamforming chips, arrayed in the antenna array region over the substrate, and bonded to the redistribution structure; and
a plurality of radio frequency front-end chips, arrayed in the antenna array region over the substrate, and bonded to the redistribution structure, wherein the radio frequency front-end chips are respectively signal connected to the antenna electrodes, and the radio frequency front-end chips are electrically connected to the beamforming chips.

2. The antenna device according to claim 1, wherein the beamforming chips are electrically connected to a plurality of digital signal lines in the thin film circuit structure, a thickness of each of the digital signal lines is less than 1 micron, and the radio frequency front-end chips are electrically connected to the beamforming chips through a plurality of radio frequency signal lines in the redistribution structure, wherein a thickness of each of the radio frequency signal lines is greater than the thickness of each of the digital signal lines.

3. The antenna device according to claim 2, wherein a width of each of the digital signal lines is 3 microns to 10 microns.

4. The antenna device according to claim 2, further comprising:
an assembly circuit board, electrically connected to the beamforming chips through the digital signal lines.

5. The antenna device according to claim 1, wherein each of the beamforming chips is electrically connected to a plurality of corresponding ones among the radio frequency front-end chips.

6. The antenna device according to claim 1, wherein the thin film circuit structure comprises a plurality of first digital signal control circuits, respectively electrically connected to the beamforming chips.

7. The antenna device according to claim 1, wherein the thin film circuit structure comprises a plurality of second digital signal control circuits, respectively electrically connected to the radio frequency front-end chips.

8. The antenna device according to claim 1, further comprising:
a plurality of buffer circuit chips, arrayed in the antenna array region over the substrate, and bonded to the redistribution structure, wherein at least one of the beamforming chips is electrically connected to at least one of the buffer circuit chips.

9. The antenna device according to claim 1, wherein the thin film circuit structure comprises a plurality of buffer circuits, wherein the beamforming chips are electrically connected to the buffer circuits.

10. The antenna device according to claim 9, further comprising:
an assembly circuit board, electrically connected to the beamforming chips, wherein a quantity of the buffer circuits electrically connected to the beamforming chip closest to the assembly circuit board is equal to a quantity of the buffer circuits electrically connected to the beamforming chip farthest from the assembly circuit board.

11. The antenna device according to claim 1, wherein each of the beamforming chips comprises a plurality of digital-to-analog converters and a plurality of analog-to-digital converters.

12. The antenna device according to claim 11, wherein each of the beamforming chips comprises a plurality of first filters, a plurality of first mixers, a plurality of first amplifiers, a plurality of second filters, a plurality of second mixers, and a plurality of second amplifiers, wherein the digital-to-analog converters, the first filters, the first mixers, and the first amplifiers form a plurality of first sub-circuits, each of the first sub-circuits comprises a corresponding one among the digital-to-analog converters, a corresponding one among the first filters, a corresponding one among the first mixers, and a corresponding one among the first amplifiers, and the analog-to-digital converters, the second filters, the second mixers, and the second amplifiers form a plurality of second sub-circuits, and each of the second sub-circuits comprises a corresponding one among the analog-to-digital converters, a corresponding one among the second filters, a corresponding one among the second mixers, and a corresponding one among the second amplifiers.

13. The antenna device according to claim 12, wherein each of the beamforming chips comprises:
a plurality of first switching elements and a plurality of second switching elements, wherein each of the first switching elements is electrically connected to a corresponding one among the first sub-circuits, a corresponding one among the second sub-circuits, and a corresponding one among the second switching elements, wherein a plurality of circuit channels each comprise a corresponding one among the first switching elements, the corresponding one among the first sub-circuits, the corresponding one among the second sub-circuits, and the corresponding one among the second switching elements, and each of the first switching elements is configured to switch between the corresponding one among the digital-to-analog converters and the corresponding one among the analog-to-digital converters, and each of the second switching elements is configured to switch between the corresponding one among the first amplifiers and the corresponding one among the second amplifiers.

14. The antenna device according to claim 13, wherein each of the beamforming chips comprises a first variable gain amplifier and phase adjuster module, wherein the first variable gain amplifier and phase adjuster module is electrically connected to the circuit channels, and each of the circuit channels is electrically connected to at least a corresponding one among the radio frequency front-end chips.

15. The antenna device according to claim 14, wherein each of the beamforming chips comprises a first serial peripheral interface circuit, electrically connected to the first variable gain amplifier and phase adjuster module.

16. The antenna device according to claim 1, wherein each of the radio frequency front-end chips comprises a second variable gain amplifier and phase adjuster module.

17. The antenna device according to claim 16, wherein the second variable gain amplifier and phase adjuster module comprises:
a third sub-circuit, comprising a first phase adjuster, a first gain adjuster, and a third amplifier;
a fourth sub-circuit, comprising a second phase adjuster, a second gain adjuster, and a fourth amplifier;
a third switching element, electrically connected to the third sub-circuit and the fourth sub-circuit, and configured to switch between the first phase adjuster and the second phase adjuster; and
a fourth switching element, electrically connected to the third sub-circuit and the fourth sub-circuit, and configured to switch between the third amplifier and the fourth amplifier.

18. The antenna device according to claim 16, wherein each of the radio frequency front-end chips comprises a second serial peripheral interface circuit, electrically connected to the second variable gain amplifier and phase adjuster module.

19. A vehicle antenna device, comprising:
a circuit substrate, comprising:
a substrate;
a plurality of antenna electrodes, arrayed in an antenna array region over the substrate;
a thin film circuit structure, located over the substrate; and
a redistribution structure, located over the thin film circuit structure;
a plurality of beamforming chips, arrayed in the antenna array region over the substrate, and bonded to the redistribution structure; and
a plurality of radio frequency front-end chips, arrayed in the antenna array region over the substrate, and bonded to the redistribution structure, wherein the radio frequency front-end chips are respectively signal connected to the antenna electrodes, and the radio frequency front-end chips are electrically connected to the beamforming chips.
